(19) United States
(12) Patent Application Publication
(10) Pub. No.: US 2013/0155323 A1
(43) Pub. Date: Jun. 20, 2013

(54) SYSTEM AND METHOD FOR CONTENT BASED CONTROL OF MEDIA RENDERER

(71) Applicant: Comigo Ltd., Hod-HaSharon (IL)

(72) Inventors: Ronen SEGAL, Herzlia (IL); Motty LENTZITZKY, RaAnana (IL)

(73) Assignee: Comigo Ltd., Hod-HaSharon (IL)

(21) Appl. No.: 13/721,183

(22) Filed: Dec. 20, 2012

Related U.S. Application Data
(60) Provisional application No. 61/577,690, filed on Dec. 20, 2011.

(51) Int. Cl. H04N 5/445

(52) U.S. Cl. CPC H04N 5/445
USPC 348/563

(57) ABSTRACT

Systems and method are presented for controlling the settings of a media renderer, such as a television, in response to available media content and user preferences. The system may include a client terminal connected to the media renderer via a communication channel. The system may be operable to monitor media content available to the media renderer; to obtain user preferences; to compare monitored media content to the user preferences; to select control signals according to the user preferences; and to send the control signals to the media renderer via the communication line thereby adjusting the settings of the media renderer.

### RELATED APPLICATION

This application claims the benefit of priority under 35 USC 119(e) of U.S. Provisional Patent Application No. 61/577,690 filed Dec. 20, 2011, the contents of which are incorporated herein by reference in their entirety.

### FIELD AND BACKGROUND OF THE DISCLOSURE

The disclosure herein relates to systems and methods for controlling of media renderers such as televisions or the like. In particular the disclosure relates to controlling media renderers according to content available and user preferences.

A great many media options are available to the consumer. For example, a wide variety of television channels, radio stations, internet based forums, gaming platforms and the like may all be available either simultaneously or at certain time slots. It can be very difficult for the consumer to navigate such a diverse environment and to make informed decisions regarding which media to select. Indeed, consumers may be so spoilt for choice that they miss the very media items they wish to enjoy because they are involved in other media and may not know that the desired media items are available. Various systems have been suggested to manage the media consumer's choice.

Media management systems often relay media related information to the user via an overlay superimposed upon the screen of a television set or other media renderer. For example a management system may be operated via a client terminal such as a set-top-box or the like, connected to a media renderer via a communication channel.

### SUMMARY

A potential advantage of the current disclosure is the introduction of media management systems and methods which are able to control a media renderer such as a television, tablet, gaming platform or the like in response to available content and user preferences and thereby to communicate with a media consumer.

It is one aspect of the current disclosure to teach a method for controlling the settings of a media renderer according to media content available and user preferences.

Optionally, the method may comprise: connecting a client terminal to the media renderer via at least one communication channel; monitoring media content available to the media renderer; obtaining user preferences; comparing monitored media content to the user preferences; selecting control signals according to the user preferences; and sending the control signals to the media renderer via the communication line thereby adjusting the settings of the media renderer.

Variously, the at least one communication channel may be selected from a group consisting of: a USB cable, an HDMI cable, a wireless communication protocol such as Bluetooth or WiFi, or the like.

Optionally, the media renderer is selected from a group consisting of: televisions, media players, tablet computers, computers, digital picture frames and the like.

Where required, the client terminal may be selected from a group consisting of: set-top-boxes, mobile communication devices, remote control devices and telephones.

Optionally the sending of control signals may comprise at least one of: instructing the media control to select a required channel, initiating the media renderer, displaying an on-screen text string on the media renderer, displaying a picture-in-picture insert and the like.

Variously the control signals are selected from: switching input, switching output, alerting viewer, displaying overlay, routing control and initiation signals.

In some examples, obtaining of reference values may comprise configuring preference settings. Optionally, the configuring comprises at least one user selecting the preference settings. Accordingly, the method may include providing the user with a set of candidate preference settings.

Additionally or alternatively, the preference settings may be selected according to at least one characteristic of the monitored media.

Optionally, again, the preference settings are selected according to at least one characteristic of a first user associated with the client terminal. Alternatively, or additionally, the preference settings are selected according to at least one characteristic of at least one subscriber.

Where appropriate, the method may further comprise the client terminal streaming media content to the media renderer.

According to another aspect of the disclosure a system is presented for controlling media output from a media renderer. Such a system may comprise: at least one client terminal operable to send control signals to the media renderer; at least one monitor operable to analyze media content receivable by the media renderer; and at least one processor operable to compare monitored media content with reference values.

Optionally, the system may further comprise a central unit in communication with the client terminal, the central unit operable to provide media data.

In another aspect, a set-top-box client terminal is disclosed comprising a processor operable to receive media data pertaining to media content receivable by a media renderer, to select control signals for a media renderer according to at least one content related characteristic and to communicate the selected control signals to the media renderer.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the drawings:

FIG. 1A is a block diagram representing one possible configuration of selected elements of a system for content based control of a media renderer;

FIG. 1B is a block diagram representing another possible configuration for a network-based distributed system for content based control of a media renderer;

FIGS. 2A-F represent various possible screen shots of a content controlled media renderer;

FIG. 3 is a flowchart representing a method for selecting and sending content based control signals to a media renderer;

FIGS. 4A and 4B are flowcharts representing possible methods for selecting preferences for a system for content based control of a media renderer; and

FIG. 5 is a flowchart representing a method by which a system may control the output of a media renderer in response to monitored media data.

### DETAILED DESCRIPTION

Aspects of the present disclosure relate to systems and method for controlling a media renderer such as a television, computer, tablet or the like in a manner determined by the media content available thereto.

Optionally, a system may include a client terminal such as a set-top-box, mobile communication device or the like, which is operable to receive user defined preferences, monitor available media content and to control the input media renderer accordingly.

Variously, the client terminal may be connected to the media renderer via at least one input port such as an antenna jack, a cable-in jack, an AV jack, S-Video jack, Component jack, D-Sub jack, DVI jack, HDMI input jack, a USB jack or the like, and their associated cables, such as dedicated HDMI cables and the like. Thus the client terminal may provide communication channels for media streaming, control signal transfer and the like.

It is noted that the systems and methods of the disclosure herein may not be limited in its application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

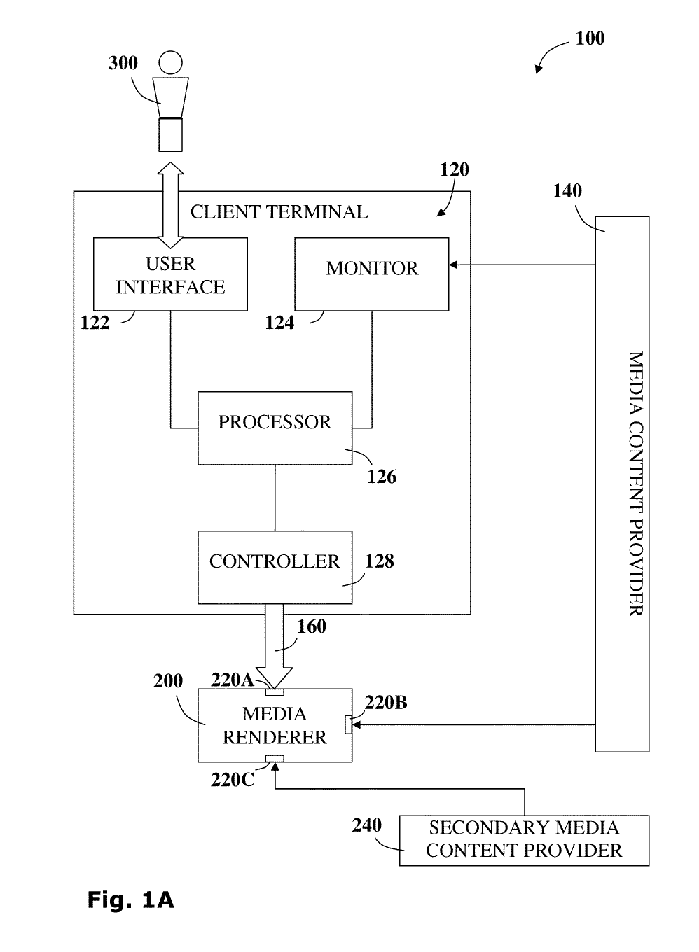

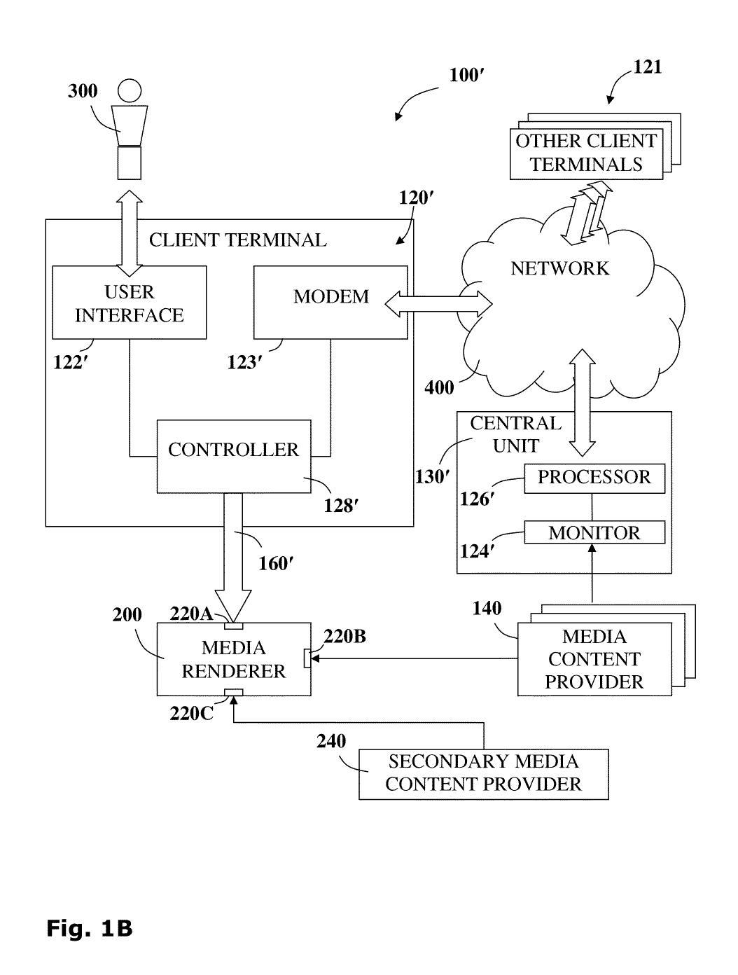

Reference is made to FIG. 1A, showing a block diagram representing one possible configuration of selected elements of a system 100 for content based control of a media renderer 200. The system 100 includes a client terminal 120 in communication with a media content provider 140 and connected to the media renderer 200 via a communication channel 160. The client terminal 120 includes a user interface 122, a media monitor 124, a processor 126 and a controller 128.

The client terminal 120 may be operable to analyze available media content and to send control signals to control the media output of at least one media renderer 200, such as a television, tablet, gaming platform, radio set, media player or the like. Optionally, the client terminal 120 may be a set-top-box (STB) connected to the media renderer via one or more connector such as a High-Definition Multimedia Interface (HDMI) connector, a Digital Visual Interface (DVI) connector, a Video Graphics Array (VGA) connector, a Universal Serial Bus (USB) connector, a Digital Interface for Video and Audio (DIVA) connector or such like, as commonly used in media communication. The connector may provide one or more communication channels 160 via which media and/or control signals may be communicated to the media renderer 200 as described herein.

Alternatively, the communication channel 160 may be provided via a wireless interface such as WiFi, Bluetooth, Wireless Gigabit Alliance (WiGig), Wireless Home Digital Interface (WHDI), Wireless USB or the like. Still other communication channels 160 providing a connection between the client terminal 120 and the media renderer 200 for use with a content-based control system 100 will occur to those skilled in the art.

By way of illustration only, one example of the communication channel 160 may stream media using Transition Minimized Differential Signaling (TMDS) and use the Consumer Electronics Control (CEC) feature available for example with HDMI connections or the like. The CEC feature may allow a user to command and control the media renderer 200 by sending control signals via the client terminal 120 perhaps using a remote control unit, a portable communication device or the like. For example, CEC Routing Control allows a user to control the switching of signal sources between input channels.

Other client terminals 120 may include computers, telephones, tablets, remote control units or the like, which may execute application programs to communicate with the media renderer.

The user interface 122 of the client terminal 120 may be used to allow a media consumer 300 to set preferences used by the system 100 to select control signals sent to the media renderer 200. Various user interfaces 122 are known in the art such as keyboards, touch screens, remote controls, pointing devices and the like and may be used to input data to the client terminal 120. Optionally, the media renderer 200 itself may serve as at least part of the user interface 122, for example by providing an output screen or input device.

The media-monitor 124 of the content-based control system 100 is provided to analyze media content available to the media renderer 200. The media-monitor 124 may be connected to at least one remote media content provider 140, such as a cable service provider, internet TV provider, local server, satellite television provider, IPTV server, OTT TV (Over The Top Television), DTT (Digital Terrestrial Television), analog television source, digital television source, media server, terrestrial television source, CCTV (Closed Circuit Television) or such like. The media-monitor 124 may be operable to receive data from the media content provider 140 relating to media content available to the media renderer 200.

The processor 126 of the content-based control system 100 is operable to receive media content data from the media-monitor 124, to compare media content data with reference values relating to user preferences, and to select control signals which the controller 128 may send to the media renderer 200.

It is noted that the media renderer may comprise a plurality of connector ports 220A-C which may be connected to a number of media sources. For example, a first port 220A may be connected to the client terminal 120, a second port 220B may be connected to the media content provider 140 and a third port 220C may be connected to a secondary media content provider 240.

Referring now to the block diagram of FIG. 1B another possible configuration for a network-based distributed system 100′ for content based control of a media renderer 200. The network-based distributed system 100′ includes a client terminal 120′ and a central unit 130′ in communication with a network 400, such as the World Wide Web, or a local area network or other such networked computing system.

The central unit 130′ may allow certain functionality of the system 100′ to perform remotely and communicate to the client terminal 120′ via a modem 123′ providing a connection to the network 400. For example, the central unit 130′ may include the monitor 124′ and a processor 126′. The monitor 124′ may be operable to monitor content provided by one or more media content providers 140 possibly via a connection to the network 400. The processor 126′ may be operable to receive user preferences from the client terminal 120′ and to communicate with the controller 128′ via the network 400. It is noted that other distributed systems may have other configurations with elements such as the processor possibly being included in the client terminal itself.

It is a particular feature of the distributed system 100′ that the central unit 130′ may centrally control other client terminals 121 possibly via the network 400. Other client terminals 121 may manage, monitor and/or control media provided to other users. Accordingly, in addition to content-based preference rules, the user 300 may be able to set user-based preference rules based, for example, upon the usage of subsets or all other users. Indeed the central unit may be further operable to manage a multiparticipant session.

Thus, for example, a user wanting to enjoy a joint group sports viewing experience with fellow sports fans may set up the system by defining a preference rule such as:
“notify when at least five friends, selected from a first defined set, are watching a sports match involving a team selected from a second defined set”,
“notify if one of the friends, selected from a defined set, invites me to a multiparticipant session”
   or the like. The example above is provided so as to illustrate one possible use of the system only, other rules will, of course, occur to the user as required.

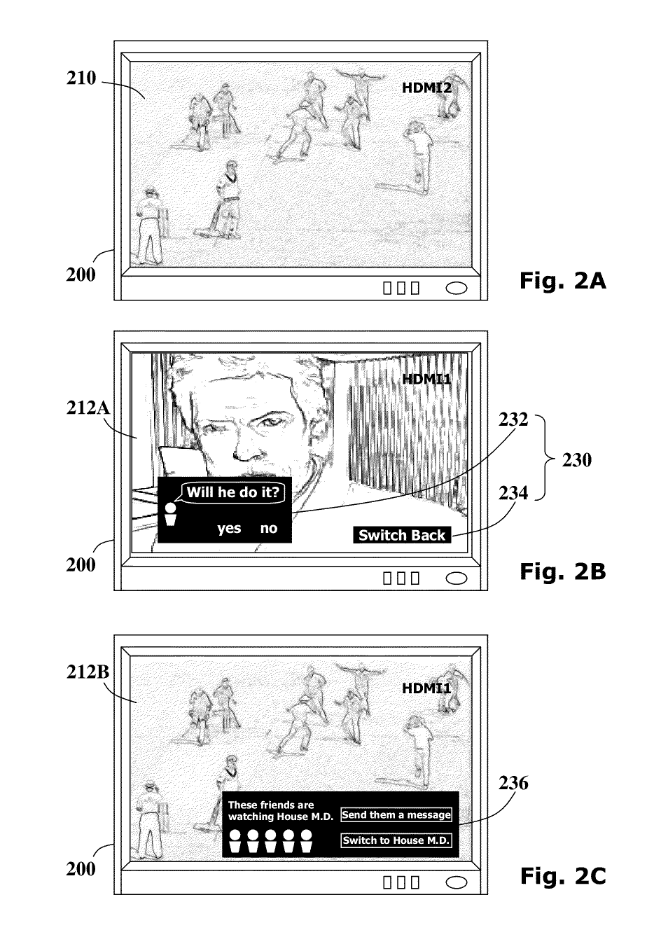

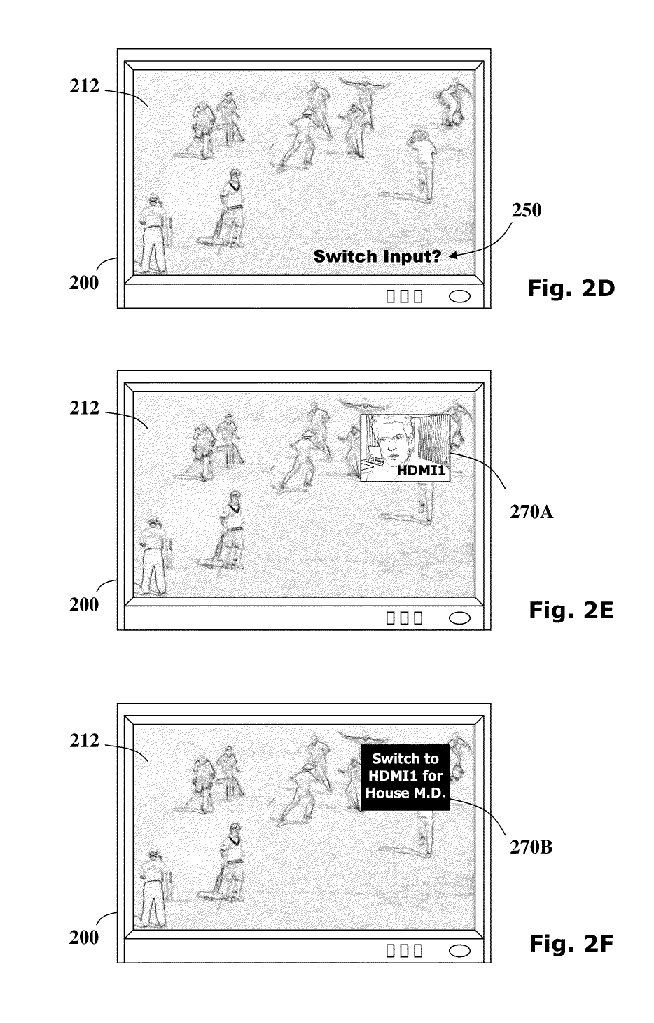

So as to illustrate a possible use of a content-based control system such as described herein, reference is now made to the screen shots shown in FIGS. 2A-F. A media renderer 200, such as a television, media player or the like, may be connected to control unit such as an STB (not shown) of a content-based control system via a first port, say the HDMI1 port of a television 200, and another media source via a second port. With particular reference to FIG. 2A, the user may have selected to view a sports match 210, say, via the second port, say the HDMI2 port of the television 200. Accordingly, the television screen displays the media received via the second port.

The user may have previously set personal preferences requesting to be notified for example when a particular show becomes available, when a certain number or selection of friends are viewing a common channel, when a desired multiparticipant session is initiated, or when other criteria are met.

It will be appreciated that if the user were viewing media via the STB it would be an overlay may be superimposed upon the displayed media. However, where the user is viewing media via a different channel, the STB may not have access to display the overlay. It is a particular feature of the current disclosure that such a limitation may be overcome in a number of different ways and that the system may still notify the user that the requested criteria have been met.

A first possible notification model is illustrated in FIG. 2B, the controller may send a control signal to the media renderer switching the television to display media streamed from the STB via the first port. Accordingly a screen may be displayed upon which the requested show 212A is displayed. It is further noted that, because the system has switched the media input to the STB port, an overlay 230 may be displayed displaying information such as a multiparticipant content, for example, an interactive poll 232 or the like. In addition a button 234 may be displayed providing an easy way for the viewer to switch back to the previously viewed channel.

It is noted that, although the first notification model described above in relation to FIG. 2B may successfully notify the user as required, it may also be quite intrusive. A user may not wish to be interrupted, for example at a crucial moment in a sports match. Accordingly, other notification models may be used to avoid such disruption.

A second possible notification model is illustrated in FIG. 2C. Here the STB is configured to detect the content currently viewed and to create a mirror channel displaying the same content 212B with a superimposed overlay 236. The controller may then send a control signal switching the input of the television to the STB port. The original media is still displayed but the overlay 236 may be used to notify the user, for example, that a certain group of friends are viewing the new channel and/or to provide buttons to switch to the new channel or to interact with the friends if required.

It is noted that the second notification model may require that the STB has access to the media provided via the second port. This may be provided, for example via a two-way communication channel with the television or by connecting the second media directly to the STB. Still other methods for providing media access will occur to those skilled in the art.

A third notification model is illustrated in FIG. 2D. A control signal may be used to instruct the television to use its own On Screen Display (OSD) 250 to display a text string indicating that the control system has identified a relevant match. It is noted that the CEC communication channel, for example, does provide an OSD display control option allowing the external box to control the display text upon the screen.

Still another notification model is illustrated in FIG. 2E. Where the television 200 allows has a split screen functionality allowing more than one channel to be displayed upon the screen simultaneously for example using Picture In Picture (PIP) display, the controller may instruct the television 200 to display a PIP inset 270A of the channel receiving media from the STB port. Accordingly the STB may stream the desired media via the STB port and display this in the PIP inset 270A within the original screen 212. Thus, the user may be made aware of the alternative media content available. Alternatively, as illustrated in FIG. 2F, the STB may provide a notification message filling the whole of the PIP inset 270B which may then be displayed to the user to provide the desired information.

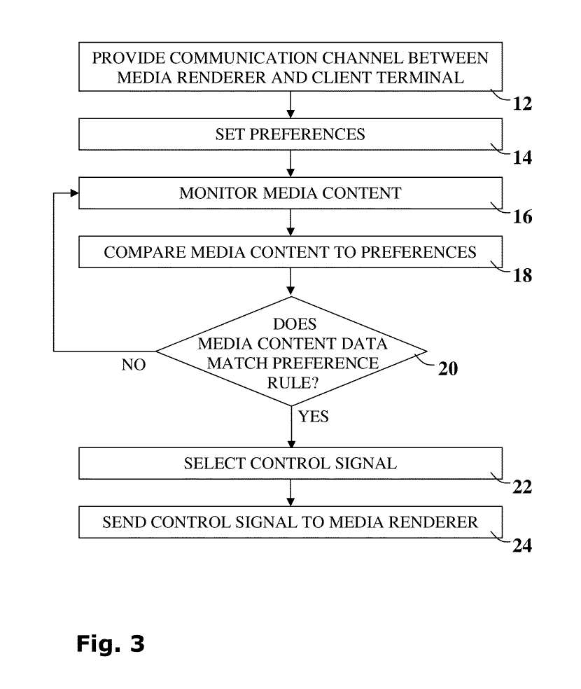

Reference is now made to the flowchart of FIG. 3, representing a method for selecting and sending content based control signals to a media renderer. The method may be implemented in a system such as a described hereinabove so that a controller, for example in a Set-Top-Box (STB) may control a media renderer to provide requested media for a user or otherwise notify a user of the availability of selected media.

The method includes providing a communication channel between a media renderer, such as a television set, radio set or the like and a client terminal 12, such as an STB or a mobile communication device, setting user preferences 14, monitoring media content available to the media renderer 16, comparing available media content to the preferences 18, deciding if preference rules are met 20, selecting a control 22 and sending the selected control signals to the media renderer 24. As described in greater detail below, control signals may be sent to instruct the media control to select a required channel, initiate the media renderer, display an on-screen text string on the media renderer, display a split screen or the like.

As noted above, a variety of communication channel may be used to connect the media renderer to the client table. For example be one or more connector such as a High-Definition Multimedia Interface (HDMI) connector, a Digital Visual Interface (DVI) connector, a Video Graphics Array (VGA) connector, a Universal Serial Bus (USB) connector or such like. The connector may provide one or more communication channels 160 via which media and/or control signals may be communicated to the media renderer 200 as described herein. Alternatively, the communication channel 160 may be provided via a wireless interface such as WiFi, Bluetooth, Wireless Gigabit Alliance (WiGig), Wireless Home Digital Interface (WHDI), Wireless USB or the like.

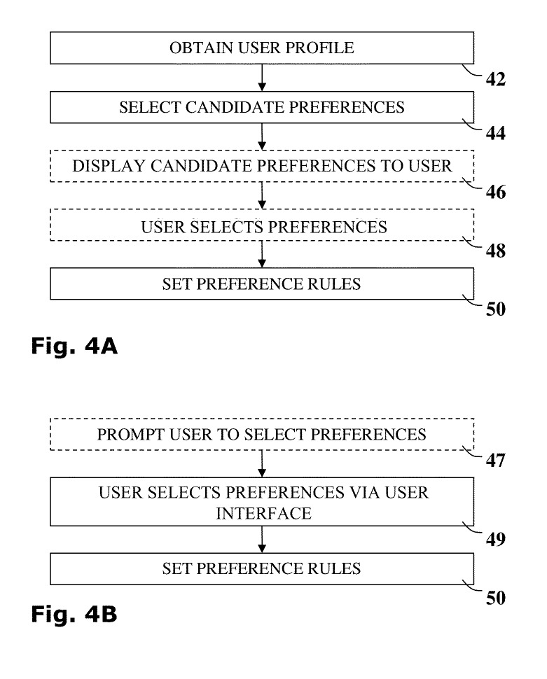

User preferences may be set either automatically or manually in a variety of manners. By way of illustration, two methods for selecting user preferences are illustrated in the flowcharts of FIGS. 4A and 4B.

With particular reference to FIG. 4A, automated preferences may be selected for the user based upon previous usage or other user characteristics. Such a method may include: obtaining a user profile specific to the user 42, selecting candidate preferences automatically 44 and setting preference rules accordingly 50. Optionally, the candidate preferences may be presented to the user 46 such that the user may select which of the suggested preferences are to be set 48. Additionally or alternatively, referring to FIG. 4B, the user may select personal preferences manually via the user interface 49, optionally after being prompted to do so by the system 47.

In selected embodiments personal preferences may further be set to control the viewing environment, for example by controlling volume level, brightness, contrast, or the like. Alternatively or additionally preferences may be used to control ambient environmental conditions such as air conditioning, lighting levels or the like via environmental controllers.

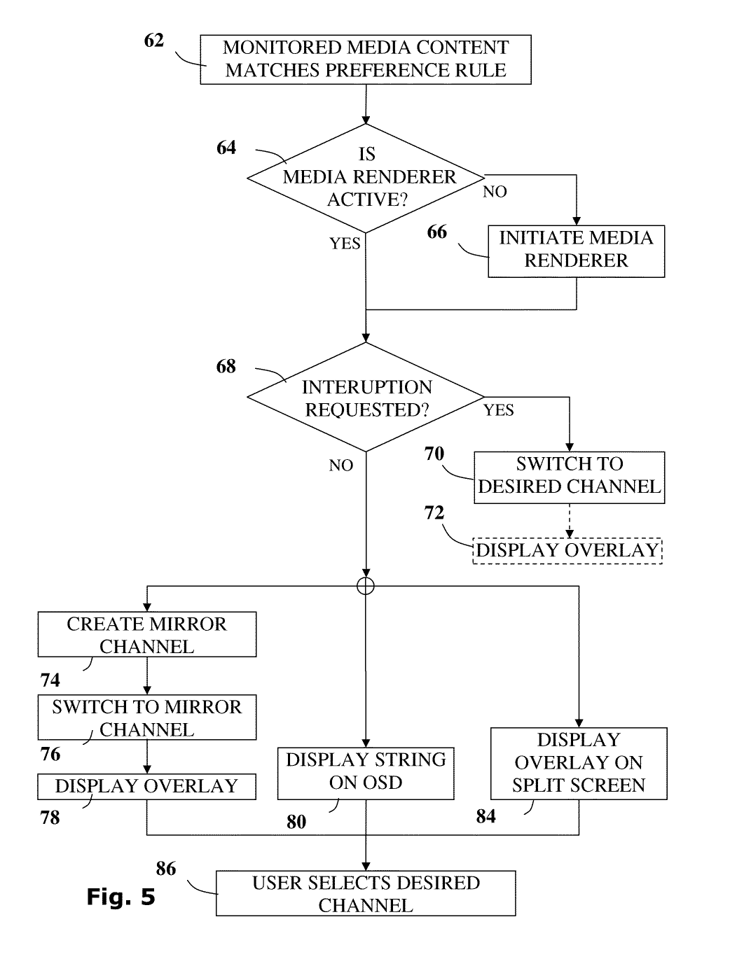

Referring now to the flowchart of FIG. 5 a method is represented by which a system may select and send control signals to control the output of a media renderer in response to monitored media data. Alternatively or additionally, control signals may be selected and sent in response to triggers such as incoming communications such as telephone calls, emails, texts or the like which may be received to a client terminal. When the monitored media content matches one or more preference rules which may be set, for example as described above, a selection algorithm may be initiated 62. The system may check to see if the media renderer is active, inactive or in some standby mode 64. If the media renderer is not active, the media renderer may be started up 66 in order to display the media or notification selected.

If the media renderer is active the controller may switch the media renderer to the desired channel 70. For example a control signal may be sent selecting the input port of the media renderer which is connected to the client terminal so that the client terminal is able to control the displayed content and optionally display a superimposed overlay 72, as required.

As noted above, automatically switching channels may be obtrusive to the user. Accordingly, the user may be able to specify whether and how they require an interruption to be made. The system may then only switch the channel if an interruption has been requested 68.

Where no interruption is requested the system may respond in a number of ways, for example by creating a mirror channel 74 presenting the same media content as the channel currently accessed. The system may then switch to the mirror channel 76 without interrupting the media content being accessed. A notification may then be displayed by superimposing an overlay upon the mirror channel 78. Accordingly the user may make an informed decision to select which media content to access 86.

Alternatively, a control signal may be sent instructing the media renderer to display a notification string using its own On Screen Display (OSD) 80. The user may then choose to switch channel or not according to requirements.

Alternatively, again, where applicable a control signal may be sent to the media renderer to display a selection of channels upon a split screen 84. For example an insert may be displayed over the currently viewed channel displaying system controlled content such as an alternative channel, an overlay or the like.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A method for a media renderer, comprising:
connecting a client terminal to a media renderer via at least one communication channel;
monitoring media content from a plurality of media content channels which are available to the media renderer via a plurality of ports;
obtaining at least one rule associated with a certain of said plurality of media content channels;
performing an analysis of said monitored media content to determine accordingly if said at least one rule is met;
selecting control signals according to the determination; and
sending the control signals to the media renderer via the communication line thereby instructing the media renderer to switch between a currently displayed content channel from said plurality of media content channels and said certain media content channel or instructing the media renderer to render a superimposition of data from said certain media content channel on a display of said currently displayed content channel.

2. The method of claim 1, wherein the at least one communication channel is selected from a group consisting of: a Universal Serial Bus (USB) cable, an High-Definition Multimedia Interface (HDMI) cable and a wireless communication protocol.

3. The method of claim 1, wherein the media renderer is selected from a group consisting of: televisions, media players, tablet computers, computers and digital picture frames.

4. The method of claim 1, wherein the client terminal is selected from a group consisting of: set-top-boxes, mobile communication devices, remote control devices and telephones.

5. The method of claim 1, wherein said sending of control signals comprises at least one of: instructing a media control of said media renderer to select said certain media content channel, initiating the media renderer, displaying an on-screen text string on the media renderer and displaying a picture-in-picture insert.

6. The method of claim 1, wherein said control signals comprise a control signal selected from a group consisting of switching input, switching output, alerting viewer, displaying overlay, routing control and initiation signals.

7. The method of claim 1, wherein said obtaining comprises configuring by a user preference settings which comprises said at least one rule.

8. The method of claim 7, wherein said configuring comprises at least one user selecting said preference settings.

9. The method of claim 8, further comprising providing said user with a set of candidate preference settings.

10. The method of claim 7, wherein said preference settings are selected according to at least one characteristic of said monitored media content.

11. The method of claim 7, wherein said preference settings are selected according to at least one characteristic of a first user associated with said client terminal.

12. The method of claim 7, wherein said preference settings are selected according to at least one characteristic of at least one subscriber.

13. The method of claim 1, further comprising said client terminal streaming media content to said media renderer.

14. A system for controlling media output from a media renderer comprising:
a controller operable to send control signals to a media renderer; a plurality of ports which receives a plurality of media content channels from a plurality of different media sources;
a monitor operable to analyze media content from said plurality of media content channels, said media content being receivable by the media renderer; and
a processor operable to determine if said monitored media content complies with at least one rule associated with a certain of said plurality of media content channels;
wherein said control signals are set to instruct, in response to said determination, said media renderer switch between a currently displayed content channel from said plurality of media content channels and said certain media content channel or instructing the media renderer to render a superimposition of data from said certain media content channel on a display of said currently displayed content channel.

15. The system of claim 14, further comprising a central unit in communication with said controller via a network, said central unit comprises said monitor and said processor.

16. A set-top-box client terminal comprising a processor operable to receive at least one content related characteristic pertaining to media content from a plurality of media content channels receivable by a media renderer, to select control signals for a media renderer according to said at least one content related characteristic and to communicate the selected control signals to the media renderer to instruct said media renderer to switch between a currently displayed content channel from said plurality of media content channels and said certain media content channel or instructing the media renderer to render a superimposition of data from said certain media content channel on a display of said currently displayed content channel.

17. The method of claim 1, further comprising instructing said media render to present a user interface in response to said determination and confirming said switch by a user using said user interface.

18. The method of claim 1, wherein said superimposition is generated by forming a picture in picture inset of said data related to said first media content channel in said display.

19. The method of claim 1, wherein said superimposition is generated by combining said data related to said first media content channel with a mirror of said second media content channel.

20. The method of claim 1, wherein said switching comprises switching from providing said second media content channel to said media render to providing said first media content channel and said second media content channel to said media render in a split screen.
